(19) United States
(12) Patent Application Publication
(10) Pub. No.: US 2004/0128134 A1
(43) Pub. Date: Jul. 1, 2004

(54) Object loading system and method

(76) Inventors: Jerry Dennis Sacks, Houston, TX (US); James Michael Parks, Richmond, TX (US); Kenneth Ray Vestal, Houston, TX (US)

Correspondence Address: Wendy K. Buskop, Buskop Law Group, P.C., Suite 500, 1717 St. James Place, Houston, TX, 77056, US

(21) Appl. No.: 10/736,162

(22) Filed: Dec. 15, 2003

Related U.S. Application Data
(60) Provisional application No. 60/436,138, filed on Dec. 23, 2002.

(51) Int. Cl. G10L 21/00

(52) U.S. Cl. 704/270

(57) ABSTRACT

The invention is a method for loading object on a transport vehicle using a mobile computer with text-to-speech software adapted for communication between a loader server system and a user wherein the method entails transmitting a request from the computer to the loader server system to obtain a list of objects to be loaded, generating a summary of the objects to be loaded, providing the summary using via the text-to-speech software, acknowledging receipt of the summary, identifying an object to determine if the object is to be loaded, advising the user with the text-to-speech software if the object is correct, acknowledging the object has been loaded, repeating these steps until all objects have been loaded, providing an acknowledgement to the server of the results of the loading, and transferring the results from the loader server systems to the at least one external computer system.

### CROSS-REFERENCE TO RELATED APPLICATIONS

This application claims priority to copending U.S. Patent Application Serial No. 60/436,138, filed Dec. 23, 2002, which is incorporated by reference herein

### FIELD OF THE INVENTION

The present invention relates to a method and system for loading an object at a warehouse onto a transport vehicle, such as a truck.

### BACKGROUND OF THE INVENTION

Current methods for loading objects onto a transport vehicle are slow and subject to error. Loaders tend to make numerous mistakes. The most costly mistakes are not locating the correct object to load onto the transport vehicle and not identifying the location an object was placed on the transport vehicle. Other errors include loading the objects onto the transport vehicle in the wrong sequence and loading the transport vehicle too slowly.

A need has existed to overcome the above problems, efficiently and economically.

### SUMMARY OF THE INVENTION

The invention overcomes the needs in the prior art by providing a method for loading object on a transport vehicle using a mobile computer. The mobile computer has a bar code reader, a display, an audio output device, an audio input device, a tactile input device, text-to-speech software, voice recognition software, loader applications software, and a radio frequency identification (RFID) reader. The mobile computer communicates between a loader server system and a user. The loader server system communicates between the mobile computer and at least one external computer system.

When a user has logged on and adapted the software, the software provides instructions to the user using the text-to-speech software to the audio output device. The instructions include a list of objects to be loaded by the user. The user acknowledges receipt of the list and locates the objects. The software validates whether the user found the correct object. The user loads the verified object. The method continues until all of the objects are loaded.

An acknowledgement is provided to the loader server system. The acknowledgment includes a report of the results of all of the method steps. The results are then transferred from the loader server system to at least one external computer system.

### BRIEF DESCRIPTION OF THE DRAWINGS

The present invention will be explained in greater detail with reference to the appended figures, in which:

FIG. 1 is a diagram of an overview of the system for use by the method of the invention;

FIG. 2 is a diagram of the mobile computer and accessories used in the inventive method and the software stored thereon;

FIG. 3 is a diagram of the steps involved in the method of the invention;

FIG. 4 is the display that is used to identify the transport vehicle;

FIG. 5 is the display used to perform the safety checks on the transport vehicle;

FIG. 6 is an overview of the system of the example;

FIG. 7 is a display of the MC configuration menu;

FIG. 8 is the speech configuration display;

FIG. 9 is the voice recognition retraining screens;

FIG. 10 is the primary loading display;

FIG. 11 is the unrecognized object display;

FIG. 12 is the object out of sequence display;

FIG. 13 is the load not open display;

FIG. 14 is the switch loads display;

FIG. 15 is the load container display;

FIG. 16 is the load object display;

FIG. 17 is the load equipment display;

FIG. 18 is the wrong zone display;

FIG. 19 is the wrong transport vehicle display;

FIG. 20 is the door status display;

FIG. 21 is the load summary display;

FIG. 22 is the objects available display;

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

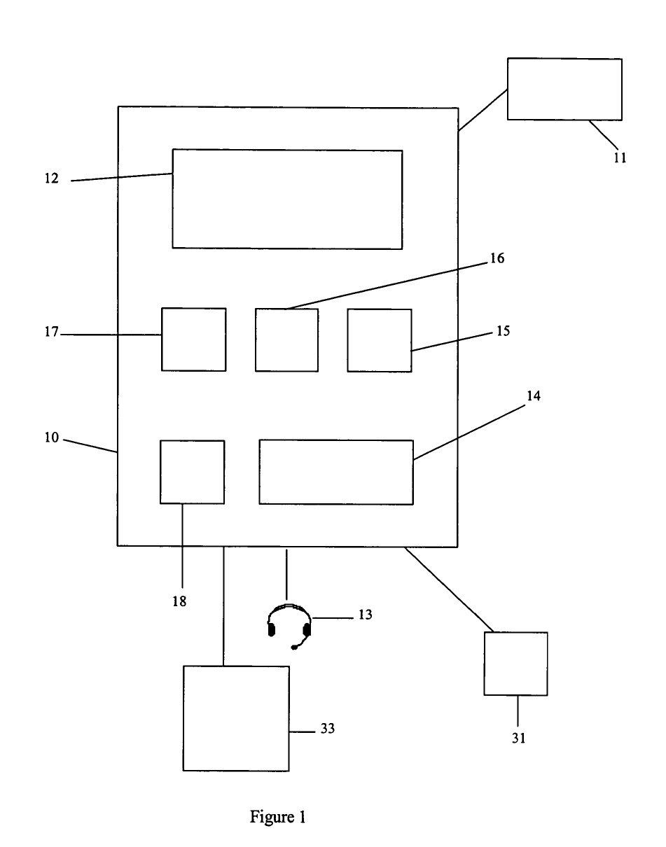

In the preferred embodiment, the invention relates to a method for loading objects on a transport vehicle. The method is shown in FIG. 1.

The method uses a mobile computer (10). The mobile computer has a bar code reader (11), a display (12), an audio output device (13), an audio input device (31), a tactile input device (14), text-to-speech software (15), voice recognition software (16), loader applications software (17), a printer (33) and radio frequency identification (RFID) reader (18). The objects to be loaded can also be a transport device containing product, product, or a piece of equipment.

The mobile computer is a model number PDT8146-D4BA30WW or PDT8146-T4AB30WW or similar device available from Symbol Technologies, Inc. The bar code scanner can be a scanner that is part of the mobile computer or a wireless scannerlike the CRS-1-20000-00 Wireless Bluetooth Ring Scanner available from Symbol Technologies. The audio input device, or headset is a Knowles Acoustics headset, Single Ear (Part No. VR3344) or Knowles Acoustics (Model TC-6300-314-1121-00). The voice recognition software can be Speech2Go Software or Vocom 3200 both available from ScanSoft, Inc. or Mobile Conversay MCSDK from Conversational Computer Corporation. The text-to-speech software can be ScanSoft Inc.'s RealSpeak Solo Software. A typical wireless communication radio for the mobile computer is a Bluetooth Connection K it consisting of CompactFlash I/O Bluetooth Card, Type I provided by Socket Communications. The communications network which would enable the mobile computer to communicate to the loader server system in a wireless mode would be the Spectrum24 Wireless Network from Symbol Technologies. These models and manufacturers, as well as products similar in nature, can be used in the preferred embodiment of the invention.

The method can also use a printer (33), such as an QL320 or QL420 Printer from Zebra Technologies. A holster for the printer is Systems Application Engineering's Soft Pack Printer Holster or SAENT-03. The holsters for the mobile computer are provided by Symbol Technologies, Part Number 11-53814-01.

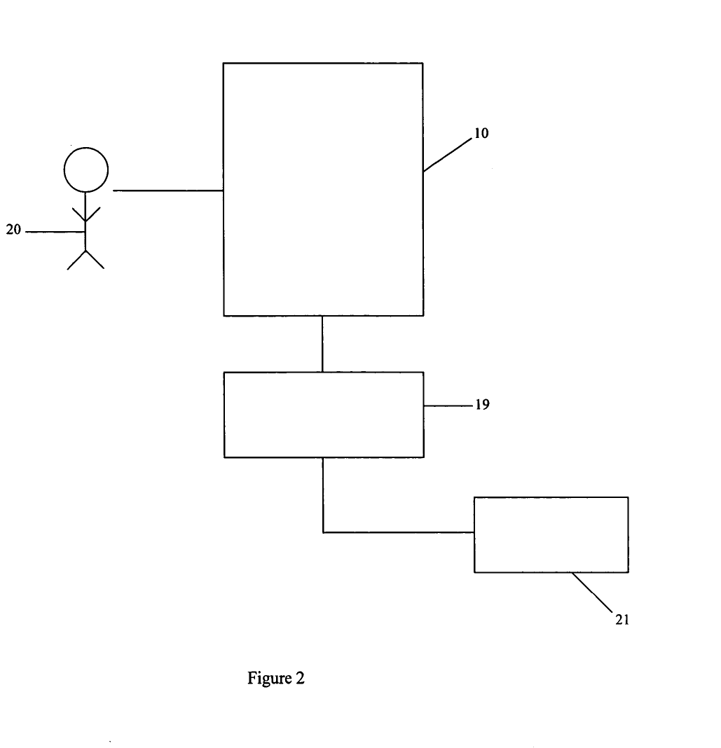

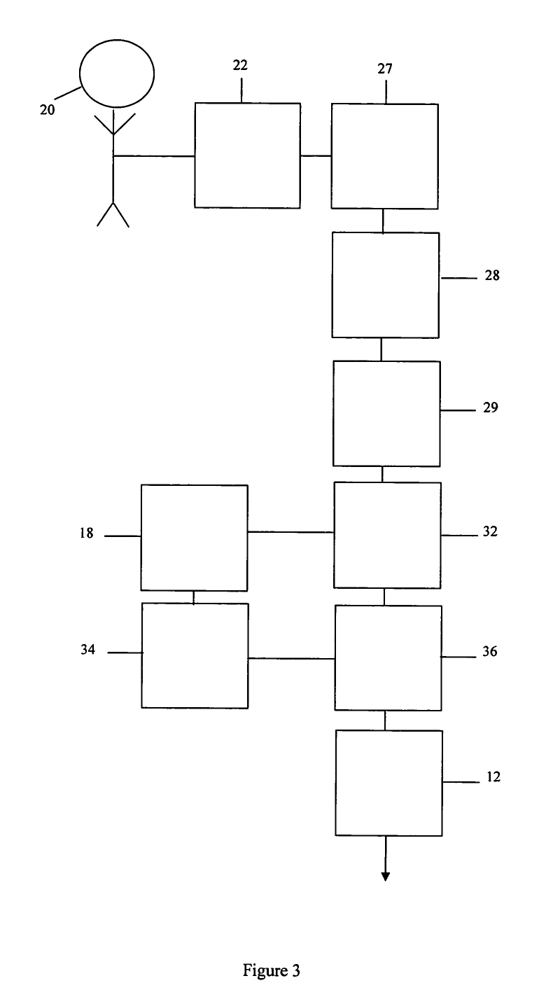

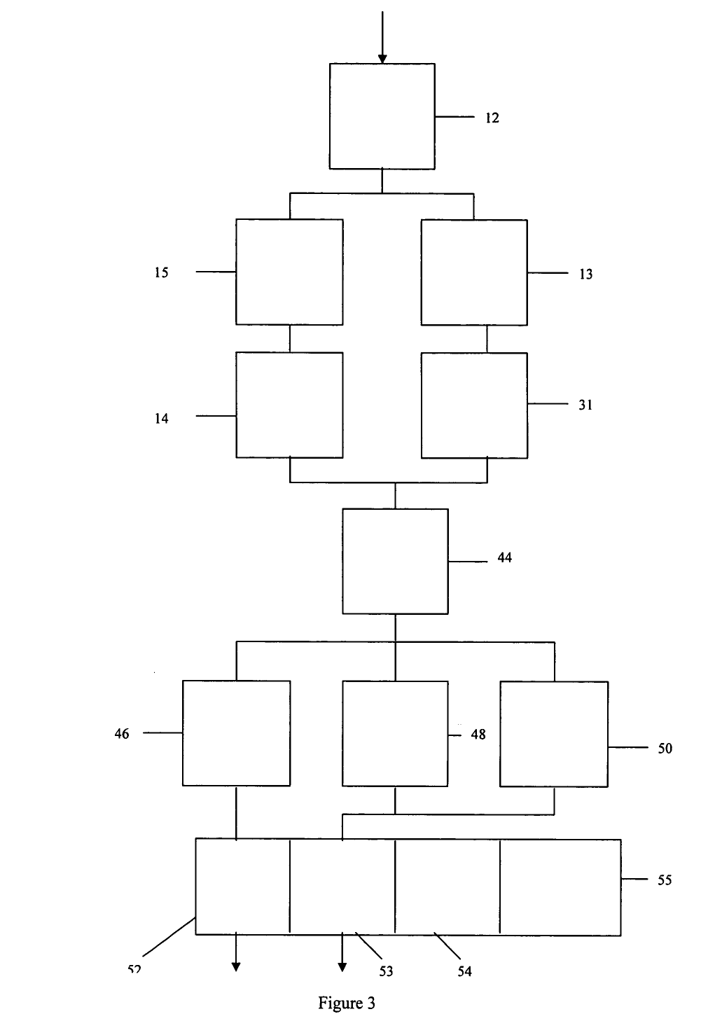

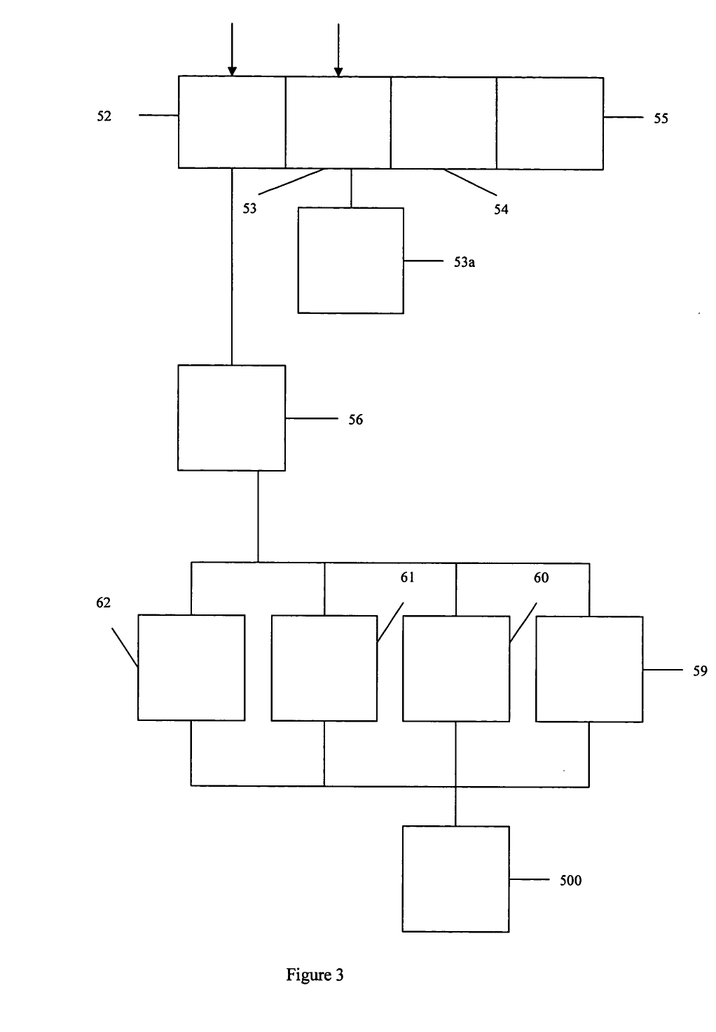

The mobile computer is adapted to facilitate communication between the loader server system (19) and a user (20) as shown in FIG. 2. The loader server system aids in transferring data between the mobile computer and at least one external computer system (21).

The method begins by the user, herein also referred to as the loader, entering a user code (22) to log onto the mobile computer and training the voice recognition software to recognize the user's speech. The user (20) provides instructions (26) from the loader applications software (27) then provides information (28) from the loader applications software to the display. The user provides this information by using the text-to-speech software (29).

Next, the user transmits a request (32) from the mobile computer to the loader server system (18) to obtain a list (34) of objects to be loaded. The applications software generates a summary (36) of the objects to be loaded from the list (34) and displays the summary of the objects to be loaded on the display (12). The summary of the objects to be loaded is transmitted via the text-to-speech software (15) to the audio output device (13). The user acknowledges the summary of objects to be loaded using either the tactile input device (14) and or the audio input device (31).

The user identifies the object (44) and determines if the object is to be loaded. The user accomplishes this by speaking the characters identifying the object into the audio input device (46), scanning a barcode on the object (48), or reading the RFID data on the object (50).

After the user identifies the object (44) the text-to-speech software advises the user whether the object can be loaded (52), cannot be loaded (53), is out of the load sequence (54), or the object is for a different load (55). If the object is not to be loaded, the user then attempts to find the correct item to be loaded (53a) using the above method steps. The method can also include the additional the step of alerting the user if the object is missing prior to loading.

When the correct item has been loaded by the user, the user can acknowledge the object (56) has been loaded. The user can provide acknowledgement using the voice recognition software. The user can bar code scan the transport vehicle (59) or can bar code scan the location of the transport vehicle (60). In addition, the user can read the RFID tag for the transport vehicle (61) or read an RFID tag for the location of the transport vehicle (62). The acknowledgement word can be “ready” (500).

The user then repeats the steps of identifying the correct items and the acknowledging the loading of the item until all of the items are loaded.

An acknowledgement is provided to the loader server system. The acknowledgment includes a report of the results of all of the method steps. The results are then transferred from the loader server system to at least one external computer system.

In an alternative embodiment, the method can further involve the step of using the mobile computer to obtain status information about the user. The information is an indication of the user's performances compared to the expected completion time for the loading method.

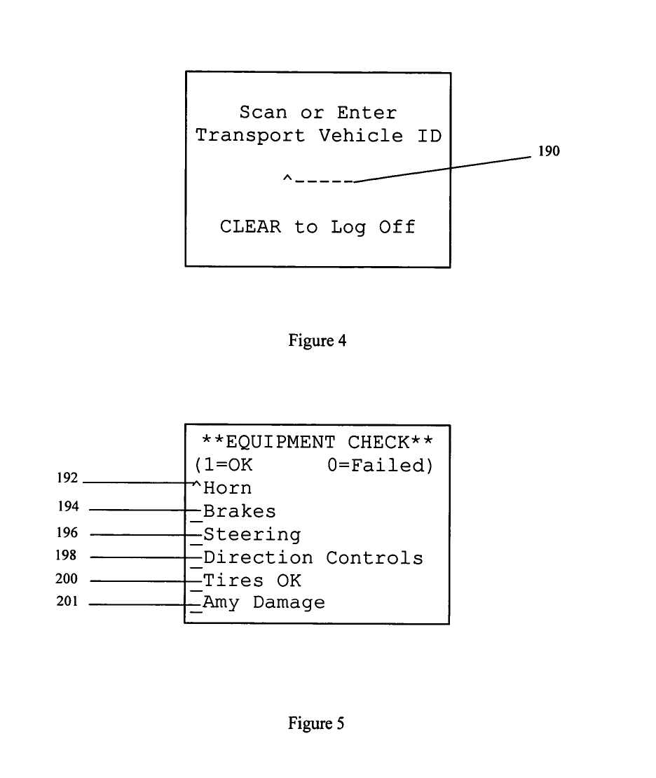

The method can also involve the user identifying the transport vehicle that moves the transport devices unto the load (190) as shown in FIG. 4 and numerous answers to a series of safety questions. These safety answers and questions are required from the user regarding the transport vehicle. These safety questions can be one or more of the of the following as shown in FIG. 5:

a. is the horn working? (192);

b. are the brakes working? (194);

c. is the steering working? (196);

d. are the direction controls working? (198);

e. are the tires and wheels inflated and undamaged? (200)

f. is there any damage to the transport vehicle? (201); and

As shown in FIG. 5, any time during the method, a second user can contact the first user from a remote location via the loader server system. The loader server system communicates with the mobile computer that, in turn, provides the communication via audio output device and display.

The object loading system provides for radio frequency (RF) directed loading of transport vehicles also known as trucks and/or trailers with objects which have been selected or indicated to be “available” for loading by some other external computer system. Mobile computers with radio communication links are used to direct the loading and to verify the accuracy of the loading by scanning barcodes on the objects being loaded or identifying the objects by speaking the correct identification characters and the zone positions in the trucks or trailers where they are to be placed.

The primary objectives of the object loading system are as follows:

a. Provide for the loading of various types of objects (e.g., containers, cases, items, or equipment);

b. Ensure that all objects required for a load are loaded into the correct transport vehicle;

c. Ensure that no objects are loaded into the wrong transport vehicle;

d. Optionally, ensure that the objects are loaded in the correct sequence and/or in the correct location in the transport vehicle; and

e. Record and produce information for the user which identifies for each delivery location (stop), each object and its location in the transport vehicle to be unloaded. This information can be produced as a printed report and/or transmitted electronically to the delivery system mobile computer.

Understanding how the term object is utilized in this document is crucial to understanding the organization, content and intent of what is written in the document. Everything which is loaded into a transport vehicle for a route is called an object. Every object is either an item, a case, a transport device (container), or a piece of equipment. An object is something to be loaded. Example object is a full case of some product or an individual product. Each transport device may contain any combination and any number of other transport devices and objects. Example transport devices are pallets, totes, carts and baskets. Each piece of equipment is something that is utilized in the performance of one or more tasks. An object of equipment may be loaded onto a trailer by a user for use during the route or it may be an object which is unloaded at a stop along the route. Examples of equipment are empty containers, freezer blankets and load bars.

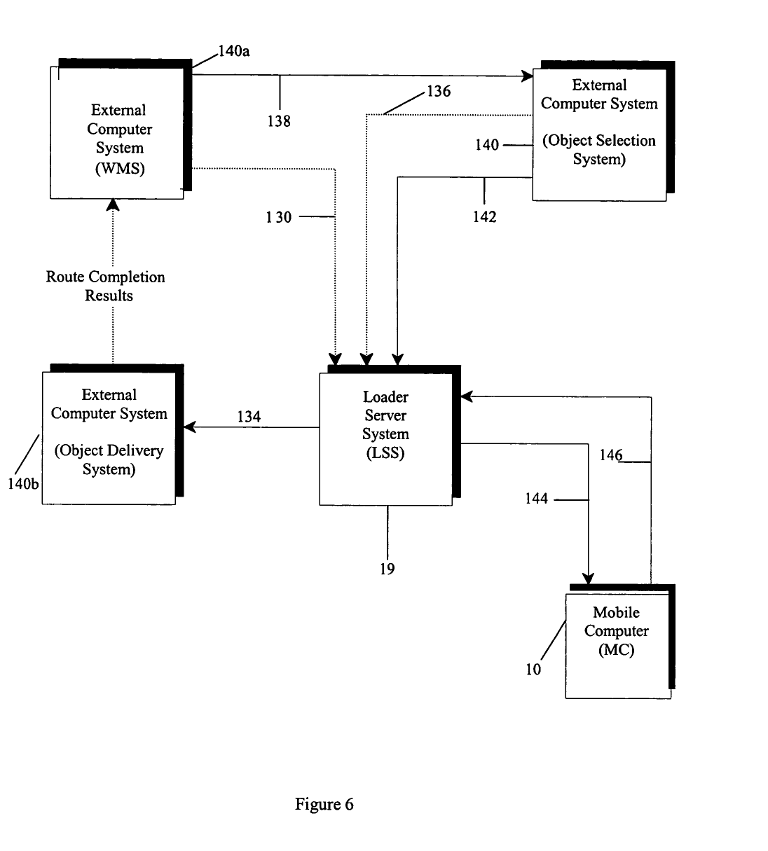

FIG. 6 shows the typical components of an object loading system with three external computers and the information which flows between the components.

The loader system server (19) either receives a loading plan (130) from a customers' existing external computer system (140a) system or it receives load plan notifications (136) derived from the product picking assignments (138) sent to an object selection system (140). As each object becomes “available” for loading, an object available notification (142) which is the second external computer is received by the LSS (19). It accepts radio messages from MC device indicating the intention of the MC user to perform an action such as loading an object into the truck/trailer. The LSS then sends loading instructions (144) back to the MC unit indicating whether it is OK to proceed or not and, if so, details about how to complete the action. The MC confirms the loading of the object by sending the loading results (146) back to the LSS. Finally, when loading for a route is complete, the LSS prepares a route plan file (134) for processing by a third external computer (140b) delivery system. This route plan defines what was actually loaded into the trailer for each route and where in the trailer each object may be found.

The loader's mobile computer directs the actions of a loader and verifies (by scanning bar codes) that the correct objects and quantities of objects are in fact loaded in the correct positions in the trailer. The MC communicates with the LSS via radio to validate objects and positions and to inform the LSS where each object is loaded.

Other external computer systems illustrated provide data for LSS and/or receive data from LSS. Examples are as follows:

a. One or more external computer systems may send lists of product picking “assignments” associated with the routes to be performed to an object selection system. Optionally, one of these systems may also send information directly to a loader server system identifying the objects to be loaded (and optionally the position or sequence of loading);

b. The object selection system provides information about what was actually picked and is now available to be loaded; and

c. The object delivery system provides information to each driver about what was ordered and actually loaded for each customer on a load.

The initial training contemplated for the system involves the following. When a user logs onto the MC, the user ID is validated. Provided the user ID is valid, an additional check is made to determine whether or not the user has voice-trained the system. If so, the MC is ready for use and the MC speaks the next appropriate prompt. However, if the user has not voice trained the system, the MC announces that it is about to train the basic system vocabularies. The MC then prompts the user to speak each of the basic system phrases. This training process requires less than 3 minutes.

The MC then announces that it is beginning training and that the user should say each word as it is displayed on the screen. The MC displays a group of basic system phrases (or words) one phrase at a time and waits for the user to say that phrase.

Once the user has spoken the phrase displayed on the screen, the MC displays the next phrase. This process continues until each of the basic system phrases has been displayed. When the last phrase has been spoken, the MC announces, “the training is done” and the MC proceeds to the next appropriate prompt.

While training the basic system phrases trains many of the words used by the MC, it is not contemplated to train all the phrases. The basic system phrases are those phrases that are common to many of the MC prompts. Other phrases exist that are only used at one or two prompts. For example, the phrase “switch load” may only be spoken by the user to change the load being worked. If the system is having difficulty understanding a certain phrase, the user may say “display menu” and train that particular word that is not being understood.

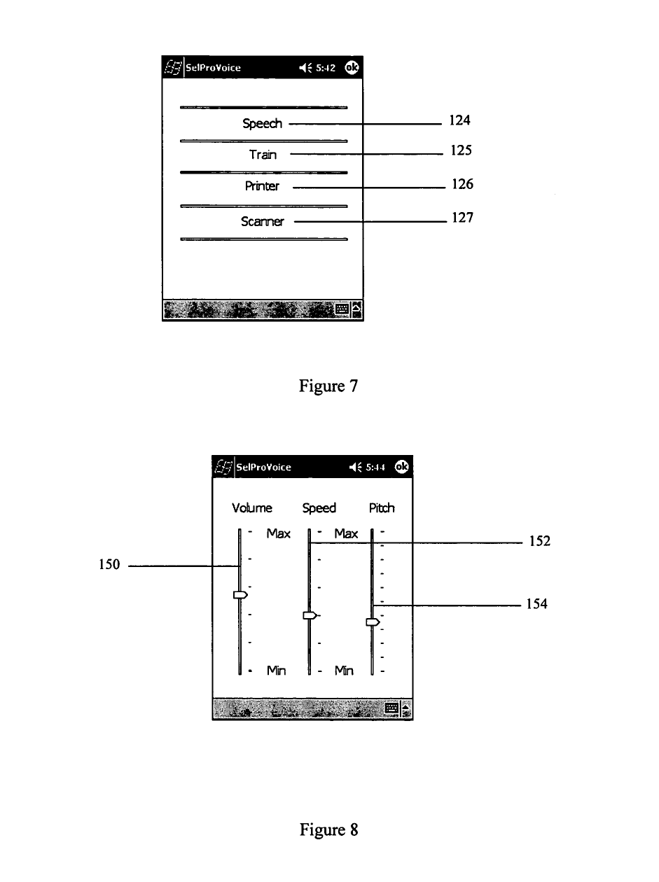

The system is contemplated to have a configuration menu that will allow the user to modify certain MC settings that were either automatically defaulted by the system or set up during initial system startup. The MC settings that may be modified include the sound of the MC voice, any previously trained word or phrase, the portable printer ID (if any) and the laser scanner ID (if any). In order to modify one of these MC settings, the user should say, “display menu” while at most MC prompts. When the MC recognizes the “display menu” command, the MC displays the system configuration menu shown in FIG. 7 and prompts the user to speak the desired menu function.

The user may say one of the following four words to select the corresponding function:

a. “Speech” (124)— Allows the user to modify the volume, speed and pitch of the MC voice;

b. “Train” (125)— Allows the user to retrain a particular word or phrase;

c. “Printer” (126)— Allows the user to change label printers. If the MC does not support a portable label printer, the MC announces, “There are no printers configured” and exits the system configuration menu; and

d. “Scanner” (127)— Allows the user to change laser scanners. If the MC does not support a laser scanner, the MC announces, “There are no scanners configured” and exits the system configuration menu.

Note, if the user decides he does not want to perform any of the menu functions at this time, he may also say, “cancel” (or press the clear key) to exit the system configuration menu. When this is done, the MC repeats the prompt that was spoken before the user said, “display menu”.

When the MC is first started, the volume, speed and pitch of the MC voice are either set to the default values or to the last values selected by the loader. The system configuration menu allows the user to modify these parameters that control the MC voice. While the system configuration menu is displayed, the loader may say “speech” in order to configure the MC voice. When the user says “speech”, FIG. 8 is displayed.

The user may adjust the volume, speed and pitch by either taping the appropriate control on the screen or by speaking the appropriate control command. After a control is tapped or a control word is spoken, the MC makes the corresponding adjustment and then asks, “How is this?” using the adjusted MC voice. The user may continue to tap the controls or speak the control words until the MC voice is the way he wants it. The user should then say, “done” to indicate he has completed the MC voice adjustments. The user may also say, “cancel” to discard any adjustments made to the MC voice. Once the user has said “done” or “cancel”, the MC returns to the prompt that was spoken before the user said “display menu”.

The following control words may be spoken in order to adjust the MC voice parameters:

a. Volume (150)— Use the words “louder” and “softer” in order to increase or decrease the MC voice volume;

b. Speed (152)— Use the words “faster” and “slower” in order to increase or decrease the speed of the MC voice; and

c. Pitch (154)— Use the words “increase” and “decrease” in order to increase or decrease the MC voice pitch, see FIG. 8.

Each user can train the MC to understand his voice and speech patterns. These speech patterns represent the various words, phrases, numbers and alphabetic characters that the user may have to say during the loading operation. When the user logs on for the very first time, the user is prompted to voice-train the system. Once the user has trained the system, it is not necessary to do so again. These speech patterns are recorded and saved on the loader server system. When the MC changes users, the speech patterns for the new user are loaded onto the MC. The MC can then recognize the commands and responses spoken by that new user.

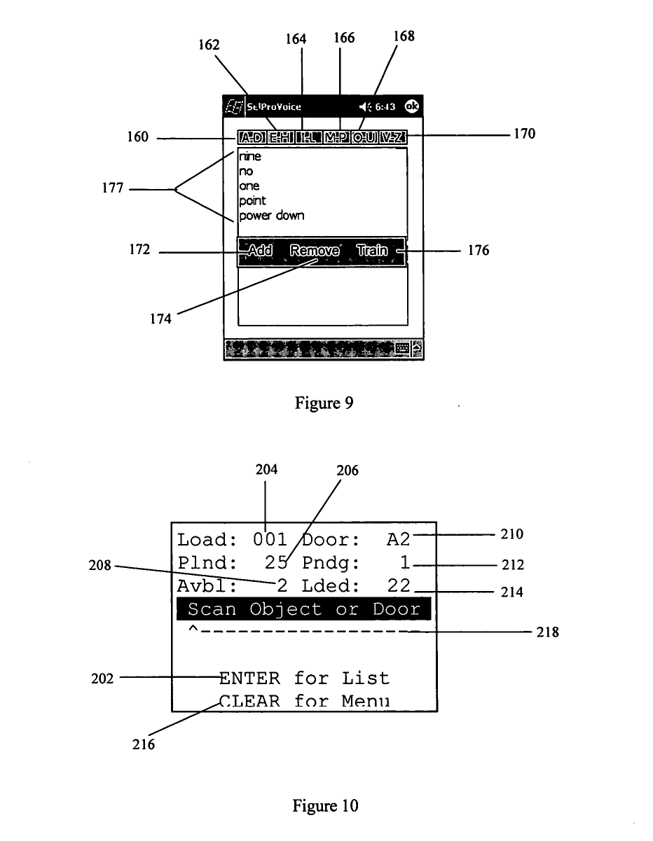

If the MC ever has trouble recognizing any word(s) spoken by the user, that word or words can be “retrained”. When a word is retrained, the selector is prompted to say that word again. Once the MC has obtained a new voice sample, the speech pattern for that word or phrase is saved and reused the next time the speech patterns for that user must be loaded onto the MC. Hopefully, by retraining the word or phrase, it will improve the ability of the MC to recognize the word the next time it is spoken. While the system configuration menu is displayed, the user may say “train” in order to retrain one or more words then another configuration screen is displayed, see FIG. 9. FIG. 9 has touch points (buttons) (160, 162, 164, 166, 168 and 170) that allow the user to select groups of words based on the alphabet characters shown on the touch points. The user c an select from the displayed words (177) and use the operations touch points to add (172), remove (174) or initiate training (176), for the selected word or words.

The retraining screen allows the user to select the word(s) to be retrained. Since there can be a large number of words from which to choose, the MC divides the words into small groups alphabetically. The headings at the top of the screen (e.g. A-D, E-H, etc.) indicate the group of words for that heading. The user should tap the heading in which the word to be trained would be found. When a heading is tapped, the list of words that may be selected for training is displayed. The user should tap on the word to be trained and then tap the ‘add’ button. If there is more than one word the user would like to train, the user should tap that word and then tap the add button again. The user may tap any group heading and add words to be trained in any order. The user may tap the remove button to remove a word from the training list. Once the user has built the list of words he would like to train, he should tap the ‘train’ button. When the train button is tapped, the MC announces that it is beginning training and that the user should say each word as it is displayed on the screen. The MC displays each of the selected words one word at a time and waits for the user to say that word.

When the last word to be trained has been spoken, the MC announces, “the training is done” and the MC returns to the prompt that was spoken before the user said, “display menu”. When the MC is first started, the user is prompted to identify the portable label printer. During the course of the shift, the printer might malfunction or otherwise break requiring that the printer be exchanged with another. The system allows the user to change printers anytime. While a menu is displayed, the selector may say “printer” in order to associate the MC with a new label printer.

When the display shown in FIG. 10 is visible, the user normally scans the barcode (218) of the next object he or she intends to load. If the barcode of the object to be loaded cannot be scanned, the user may press the “enter” (202) key to view a list of objects which are currently available for loading for the route for which the user is currently working and may then select the desired object from the list. When an object has been selected by either of the two methods described, the object loading system determines if the object selected is valid for loading at this time.

The following information is shown in FIG. 10: the load (i.e., route) (204) and door (210) currently being worked, the total number of objects planned (206) and pending (212) (“Plnd:” and “Pndg:”) for the load, and the total number of objects available (208) and loaded (214) (“Avbl:” and “Lded:”) for the load.

The display shown in FIG. 10 also allows the user to initiate some other functions. These are as follows:

a. The user may press the enter (202) key to view and select an object from a list of objects which are currently available for loading for the route for which the user is currently working;

b. The user may press the clear (216) key to view the special functions menu on which a list of additional tasks which may be performed is presented; and

c. The final other option is to scan the barcode of a warehouse door to cause the door status screen to be displayed.

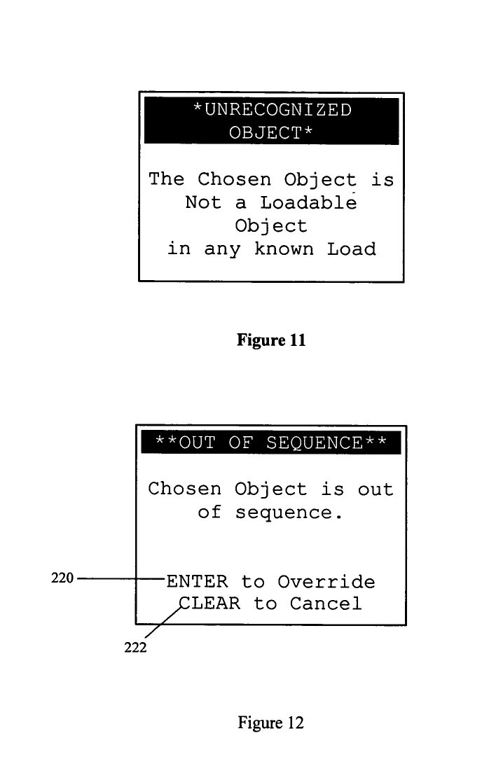

Each time the user chooses the next object he or she intends to load, loader server system searches for information about the object and performs several validity checks. Each of the possible validity check failure displays are described in the remainder of this section. If a selected object is not found in any of the load plans currently defined in the LSS, the screen shown in FIG. 11 is displayed.

If an object is invalid because the object loading sequence is predetermined and the object chosen for loading is not the next one in order, the screen in FIG. 12 is displayed. If the clear (222) key is pressed, the user can select another object to load. If the enter (220) key is pressed, the load sequence is overridden (and an override notice is sent to LSS). Loading of the object continues and the user is asked to scan/enter the zone where the object is placed in the trailer (or, if zone barcode labels are not utilized, the trailer barcode).

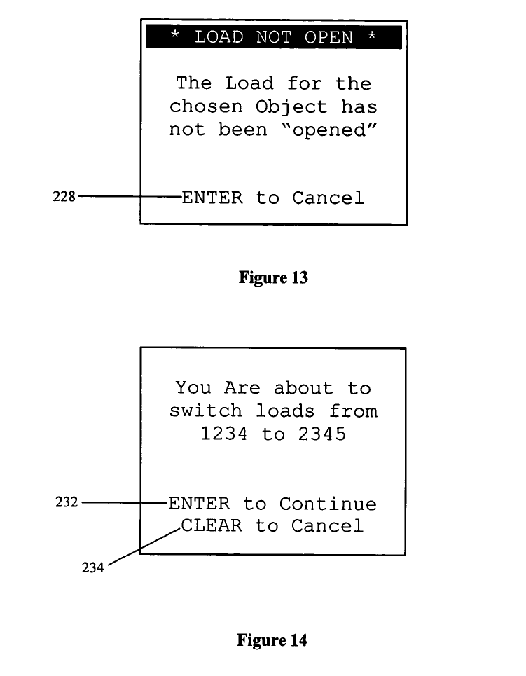

If an object is invalid because the load for the chosen object has not been “opened”, the screen shown in FIG. 13 is displayed. The loader should select another object to load. If the user presses enter (228), the loader is prompted to select another object for loading.

Users are notified each time they switch from one load to a different load, the MC checks to see if the object chosen for loading is for the same route as the route of the most recently loaded object. If the chosen object is not for the same route an audible signal is sounded and the screen shown in FIG. 14 is displayed. If the clear (234) key is pressed, the user can select another object to load. If the enter (232) key is pressed, loading of the object continues and the user is asked to enter the zone where the object is placed in the transport vehicle (or, if zone barcode labels are not utilized, the trailer barcode).

If an object has been manually selected (because it does not have a bar code), and if loader server system is configured to print object labels for objects whose labels are missing a screen is presented to allow the loader to re-print an appropriate container or object label.

After an object has been selected for loading and has been validated, one of several displays are presented to the loader to provide directions about where the object is to be loaded. The display which is presented depends upon what type of object was selected (e.g., a “container”, a “case” or an “equipment” object) and also upon some configuration options.

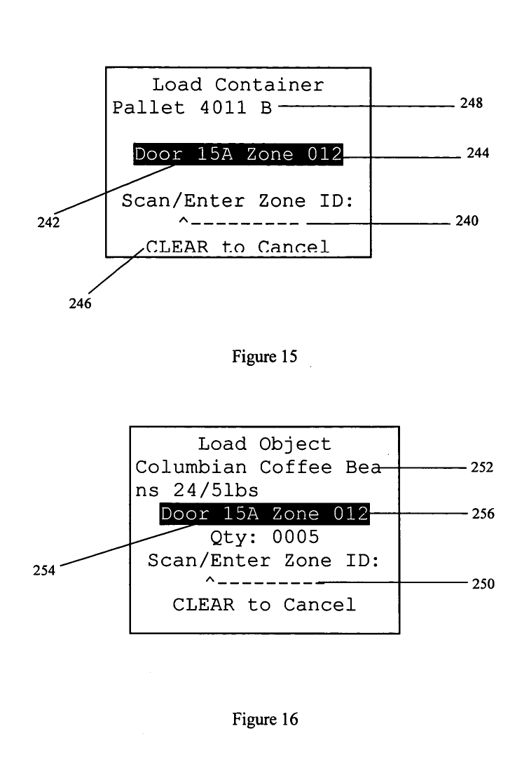

When a transport device (container) is selected for loading, the user is presented with the display shown in FIG. 15. The display shows the transport device ID (248), the door (242) and the zone (244) in the transport vehicle where the object is to be loaded.

The user is expected to scan the zone barcode (240) in the trailer where the container has been placed. If the zone label is missing or damaged, the loader may enter the zone ID manually by typing the trailer ID and zone number. Manually keyed positions are sent to the LSS to be saved as overrides. If the loader decides not to load this object at this time, the clear (246) key can be pressed to cancel the loading of the object.

When an object (e.g. case) that is not part of a transport device is selected for loading, the user is presented with the screen shown in FIG. 16. The display area shows the description (252) of the object and the door (254) and zone (256) where the object is to be loaded.

The user confirms the loading position in the same way as for loading a transport device described previously. However, if the loader puts the object in or on a transport device that was previously loaded, the bar code of the transport device may be scanned rather than a zone (250) or loading position. Once the position where the object was loaded is confirmed, the loader can select another object to load or select another load to work.

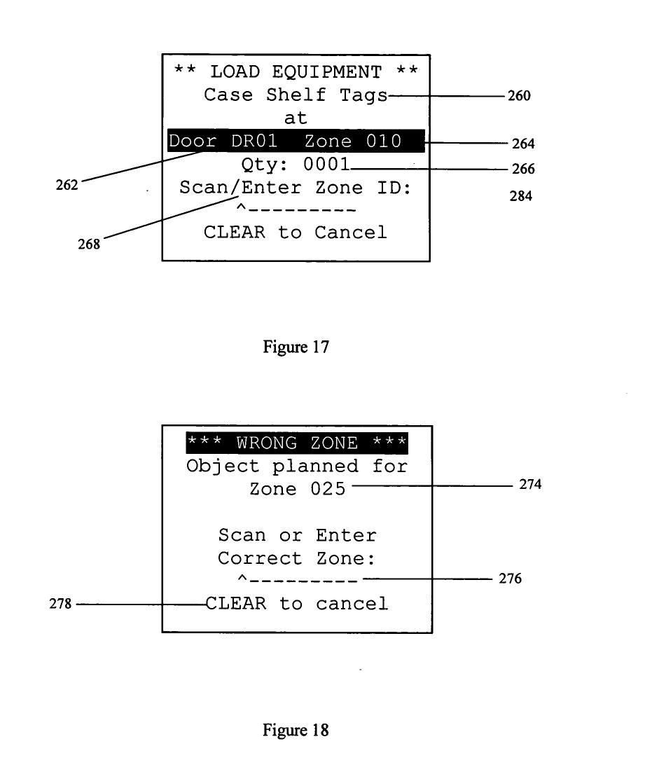

When an equipment object which was specified in the load plan is chosen, the screen shown in FIG. 17 is displayed. A gain, the display shows the equipment description (260), the door (262) and transport vehicle zone (264) where the equipment is to be loaded, the quantity of equipment (266) and requests the loader scan a barcode (268) to confirm the loading.

When object trailer loading positions are predetermined and if the user scans or keys the wrong position, the screen shown in FIG. 18 is displayed.

The user should move the object to the correct zone (274) and scan that zone label (276) (or enter the zone number), or clear (278).

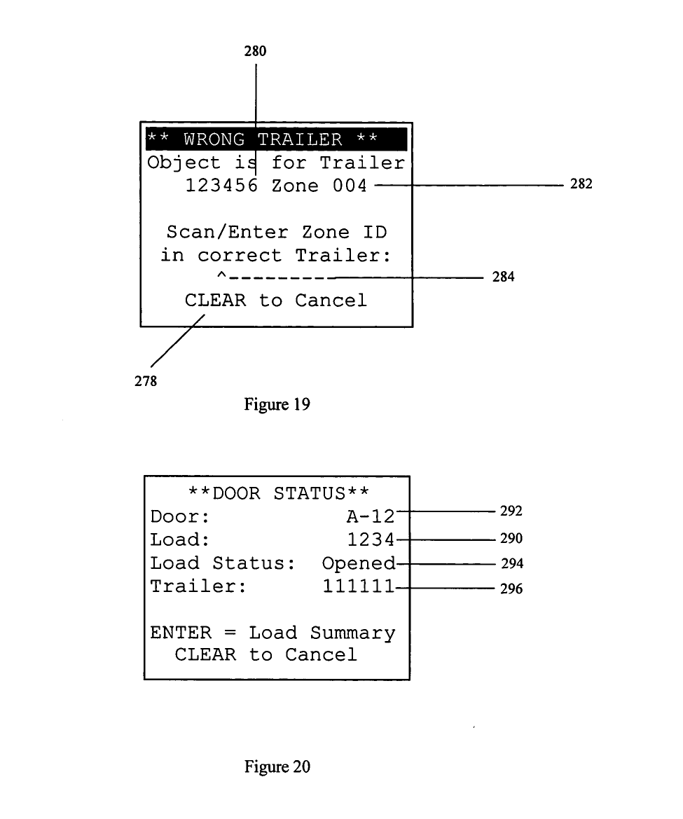

If the user scans a trailer position barcode which does not contain the correct trailer number, the screen shown in FIG. 19 is displayed.

The user should move to the correct trailer (280), plate it in the indicated zone (282) and then scan the correct zone label (284). If the user presses the clear (278) key, he or she can select another object to load.

When this display is requested either by scanning a door barcode or by requesting it via a menu, the screen shown in FIG. 20 is displayed.

The door status screen shows load number (290) of the load being worked at the door (292) and the status of the load (294) and the transport vehicle number (296). If there is no load currently associated with the door, all of the fields except the door are blank.

The load status (294) can be one of the following:

a. Pending—the load is “pending” until a trailer is assigned and the load is “opened” for loading;

b. Opened—the load is being worked;

c. Complete—all objects have been loaded; and

d. Closed—the supervisor has closed the load; it can be dispatched.

If the clear (300) key is pressed, this display is terminated and the previous display is reactivated.

If the enter (298) key is pressed, the load summary display described elsewhere is this document is activated.

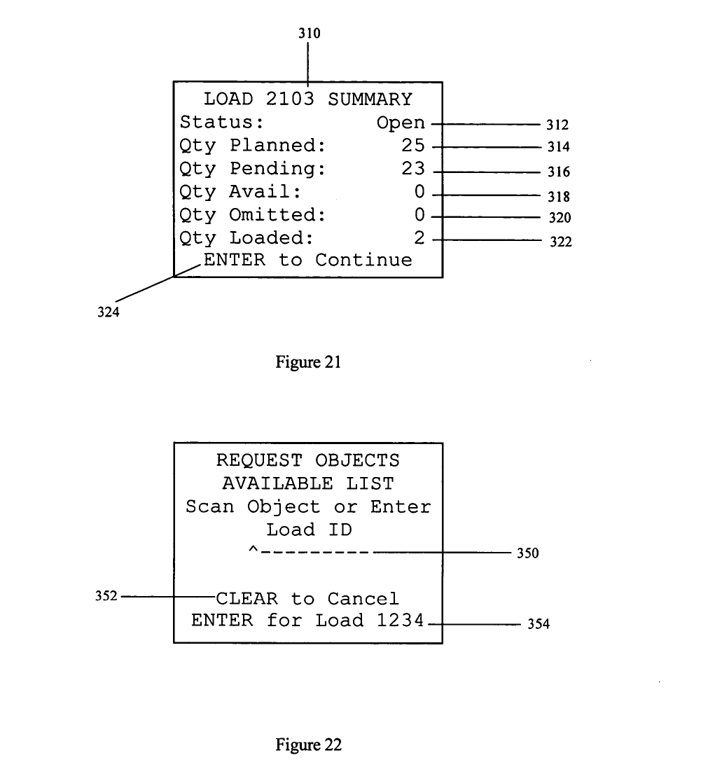

When the user (i.e., loader or supervisor) requests the load summary display, the screen shown in FIG. 21 is displayed.

The information presented on this display includes the following: the load (i.e., route) number (310), the status (312), the number of objects to be loaded (314), the number of objects which have not been loaded and are not yet “available” to be loaded (316), the number of objects currently “available” to be loaded (318), the number of objects left off the load (320), and the number of objects currently loaded (322),

Pressing the enter (324) key returns to the previous display.

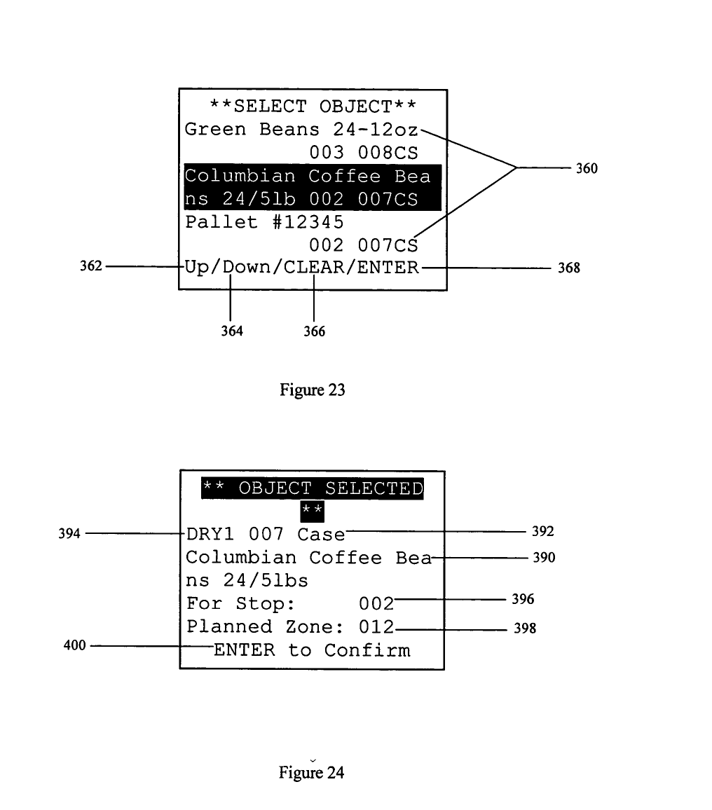

There may be several times when a Loader needs to see a list of objects which have not been loaded (they are available) and to select an object from the list. The screen shown in FIG. 22 is displayed to allow the user to confirm the load (354) for which objects are to be listed, or to specify a different load (350).

Pressing clear (352) returns to the previous display.

Once a valid load ID is known, the screen shown in FIG. 23 will be displayed listing the objects which are available for loading for that specific load (360).

The up (362) and down (364) keys can be used to scroll the list. Pressing clear (366) returns to the previous display.

When the enter key (368) is pressed, the screen shown in FIG. 24 is displayed showing the selected object. The display shows the description of the selected object (390), the type of object (392), the warehouse area (394), location (stop) at which object will be delivered (396) and the zone (398) where the object is loaded or to be loaded.

Pressing enter (400) confirms the choice and causes this function to be terminated and the function which initiated this function to be resumed.

The invention has been described with emphasis on the preferred embodiments, it should be understood that within the scope of the appended claims the invention might be practiced other than as specifically described herein.

What is claimed is:

1. A method for loading object on a transport vehicle comprising:
a. using a mobile computer having a bar code reader, a display, an audio output device, an audio input device, a tactile input device, text-to-speech software, a voice recognition software, loader applications software, a printer and radio frequency identification (RFID) reader wherein the mobile computer is adapted for communication between an loader server system and a user and the loader server system is adapted for communication between the mobile computer and at least one external computer system;
b. entering a user code to log onto the mobile computer;
c. training the voice recognition software by the user;
d. providing instructions to the user from the loader applications software using the text-to-speech software to the audio output device and providing information from the loader applications software to the display;
e. transmitting a request from the mobile computer to the loader server system to obtain a list of objects to be loaded;
f. using the applications software to generate a summary of the objects to be loaded from the list;
g. displaying the summary of the objects to be loaded on the display;
h. providing the summary of the objects to be loaded using via the text-to-speech software to the audio output device;
i. performing a step which is a member of the group: acknowledging the summary of objects to be loaded by the user using the tactile input device and acknowledging the summary of objects to be loaded using the audio input device;
j. identifying an object to determine if the object is to be loaded by a step selected from the group consisting of:
i. speaking the characters identifying the object into the audio input device;
ii. scanning a barcode on the object;
iii. reading a RFID data on the object;
k. advising the user with the text-to-speech software a member of the group consisting of:
i. the object can be loaded;
ii. the object is not loadable;
iii. the object is out of sequence for the load;
iv. the object is for a different load;
l. acknowledging the object has been loaded using a method selected from the group:
i. providing an acknowledgement using the voice recognition software;
ii. bar code scanning a transport vehicle;
iii. bar code scanning the location of the transport vehicle;
iv. reading an RFID tag for a transport vehicle; and
v. reading an RFID tag for the location of the transport vehicle;
m. repeating steps (j) through (l) until all objects have been loaded;
n. providing an acknowledgement to the loader server system the results of the process steps (b) through (m); and
o. transferring the results from the loader server system to the at least one external computer system.

2. The method of claim 1, wherein the acknowledgement word is “ready”.

3. The method of claim 1, further comprising the step of using the mobile computer to obtain status information for the user that is an indication of the user's performances compared to the expected completion time for steps (b) through (m).

4. The method of claim 1, wherein answers to a series of safety questions are required from the user regarding the transport vehicle into which the objects are being loaded from the group comprising:
a. are the brakes working?;
b. is the horn working?;
c. is the steering working?;
d. are there any leaks in the transport vehicle?;
e. is there any damage to the transport vehicle?;
f. are the tires and wheels inflated and undamaged?; and
g. combinations thereof.

5. The method of claim 1, wherein at any time during the method, a second user can contact the user from a remote location via the loader server system, which communicates with the mobile computer which then provides the communication via audio output device and display.

6. The method of claim 1, wherein the object is a transport device containing product.

7. The method of claim 1, wherein the object is product.

8. The method of claim 1, wherein the object is a piece of equipment.

9. The method of claim 1, wherein the method contemplates the step of alerting the user of the object is missing product prior to loading.
